(19) United States
(12) Patent Application Publication
(10) Pub. No.: US 2023/0153869 A1
(43) Pub. Date: May 18, 2023

(54) METHODS AND SYSTEMS FOR RECOMMENDING PRODUCTS AND SERVICES

(71) Applicant: Consumers Unified, LLC, Tulsa, OK (US)

(72) Inventor: Steven Rydin, Cottonwood Heights, UT (US)

(21) Appl. No.: 17/529,932

(22) Filed: Nov. 18, 2021

(51) Int. Cl. G06Q 30/02; G06Q 30/06

(52) U.S. Cl. CPC G06Q 30/0282; G06Q 30/0203; G06Q 30/0631

(57) ABSTRACT

Methods and systems described herein are directed to generating hyper-personalized service recommendations. A service recommendation system can provide a user with company recommendations based on the products and services the company provides being related to the products and services the user is interested in. The product and service recommendation system can collect information from the user and generate a user specifications based on the information. The product and service recommendation system can collect company information and generate a company schema. In some implementations, the product and service recommendation system can compare the company schema and the user specifications and generate a match score based on the comparison. The product and service recommendation system can present the user with a list of companies, that have a match score of above a threshold value, and the user can filter or sort the companies to select a company from the list.

### TECHNICAL FIELD

The present disclosure is directed to methods and systems for recommending products and services based a match score between a company schema and user specifications.

### BACKGROUND

People can buy various products or services such as home appliances, cars, houses, condos, health or vehicle insurance, etc. However, with the numerous companies that provide products and services, it can become overwhelming for a user to find a company that meets a user's needs and is economical for the user. Additionally, a user may not have the time to analyze all the companies that provide products and services before deciding.

### BRIEF DESCRIPTION OF THE DRAWINGS

FIG. 1 is a block diagram illustrating an overview of devices on which some implementations can operate.

FIG. 2 is a block diagram illustrating an overview of an environment in which some implementations can operate.

FIG. 3 is a block diagram illustrating components which, in some implementations, can be used in a system employing the disclosed technology.

FIG. 4 is a flow diagram illustrating a process used in some implementations of the present technology for generating user specifications.

FIG. 5 is a flow diagram illustrating a process used in some implementations of the present technology for generating a company schema.

FIG. 6 is a flow diagram illustrating a process used in some implementations of the present technology for determining a match score between a company schema and user specifications.

FIG. 7 illustrates an example machine learning system for providing product and service recommendations, as described herein.

The techniques introduced here may be better understood by referring to the following Detailed Description in conjunction with the accompanying drawings, in which like reference numerals indicate identical or functionally similar elements.

### DETAILED DESCRIPTION

Aspects of the present disclosure are directed to generating product and service recommendations. In a preferred embodiment, a product and service recommendation system provides a user (consumer) with company recommendations based on the products and services (e.g., insurance, warranties, electronic devices, appliances, vehicles, furniture, tools, etc.) the company provides being similar to the products and services the user is interested in. The product and service recommendation system can collect information (or data) from the user and generate user specifications based on the information. For example, the user can provide information (e.g., personal information, types of home appliances, make and model of cars, whether they want health, vehicle, or home insurance, home security, personal information, etc.) into a product and service recommendation application, and the product and service recommendation system can generate user specifications based on the information. The product and service recommendation system can collect company information (e.g., products and services the company provides, fees for the products and services, policies, membership requirements, warranties, etc.) and generate a company schema. The product and service recommendation system generates a match score based on comparing the user specifications to the company schema. For example, when the company provides every product and service the user is looking for, the product and service recommendation system assigns a match score of 100%. When the company provides some of the products and services the user is looking for, the product and service recommendation system assigns a match score of less than 100%, such as 50% (e.g., when the company provides half of the products and services the user needs). The product and service recommendation system can present the user with a list of companies that provide the products and services, and the user can filter/sort the companies to select a company from the list.

In existing systems, users are unable to view multiple companies which provide products and services they need and determine how close of a match the company is to the user's needs. The present embodiments collect user information, generate user specifications, collect company information, generate company schemas, and determine a match score between the company schemas and the user specifications. This uses coordination between multiple disparate computing systems (e.g., company data sources, user data sources, user devices, company devices, etc.) to provide a new way to view product and service recommendations. In addition, this product and service recommendation system is not merely performing the task previously accomplished by humans in a faster manner. Instead, through the described user and company schema generation, continually updating the schemas, using trained machine learning models, and generating match scores, the disclosed systems achieve more accurate results than a person could reasonably achieve. In addition, the technical processes used in the disclosed product and service recommendation system provide increased understanding of companies and the products and services the companies provide by presenting the companies and the products and services to the user with a match score related to the user's needs. Several implementations are discussed below in more detail in reference to the figures.

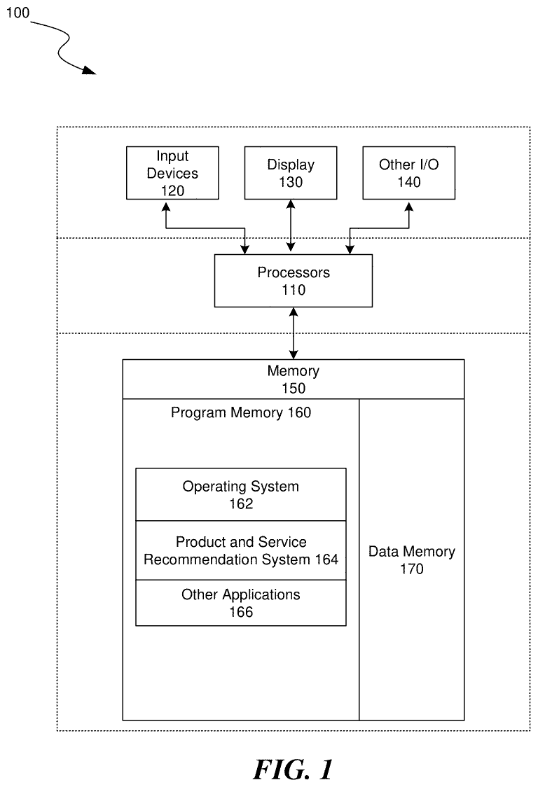

FIG. 1 is a block diagram illustrating an overview of devices on which some implementations of the disclosed technology can operate. The devices can comprise hardware components of a device 100 that generates hyper-personalized service recommendations. Device 100 can include one or more input devices 120 that provide input to the Processor(s) 110 (e.g. CPU(s), GPU(s), HPU(s), etc.), notifying it of actions. The actions can be mediated by a hardware controller that interprets the signals received from the input device and communicates the information to the processors 110 using a communication protocol. Input devices 120 include, for example, a mouse, a keyboard, a touchscreen, an infrared sensor, a touchpad, a wearable input device, a camera- or image-based input device, a microphone, or other user input devices.

Processors 110 can be a single processing unit or multiple processing units in a device or distributed across multiple devices. Processors 110 can be coupled to other hardware devices, for example, with the use of a bus, such as a PCI bus or SCSI bus. The processors 110 can communicate with a hardware controller for devices, such as for a display 130. Display 130 can be used to display text and graphics. In some implementations, display 130 provides graphical and textual visual feedback to a user. In some implementations, display 130 includes the input device as part of the display, such as when the input device is a touchscreen or is equipped with an eye direction monitoring system. In some implementations, the display is separate from the input device. Examples of display devices are: an LCD display screen, an LED display screen, a projected, holographic, or augmented reality display (such as a heads-up display device or a head-mounted device), and so on. Other I/O devices 140 can also be coupled to the processor, such as a network card, video card, audio card, USB, firewire or other external device, camera, printer, speakers, CD-ROM drive, DVD drive, disk drive, or Blu-Ray device.

In some implementations, the device 100 also includes a communication device capable of communicating wirelessly or wire-based with a network node. The communication device can communicate with another device or a server through a network using, for example, TCP/IP protocols. Device 100 can utilize the communication device to distribute operations across multiple network devices.

The processors 110 can have access to a memory 150 in a device or distributed across multiple devices. A memory includes one or more of various hardware devices for volatile and non-volatile storage, and can include both read-only and writable memory. For example, a memory can comprise random access memory (RAM), various caches, CPU registers, read-only memory (ROM), and writable non-volatile memory, such as flash memory, hard drives, floppy disks, CDs, DVDs, magnetic storage devices, tape drives, and so forth. A memory is not a propagating signal divorced from underlying hardware; a memory is thus non-transitory. Memory 150 can include program memory 160 that stores programs and software, such as an operating system 162, product or service recommendation system 164, and other application programs 166. Memory 150 can also include data memory 170, user data, company data, user specifications data, company schema data, match score data, recommendation data, machine learning data, product and service data, settings, user options or preferences, etc., which can be provided to the program memory 160 or any element of the device 100.

Some implementations can be operational with numerous other computing system environments or configurations. Examples of computing systems, environments, and/or configurations that may be suitable for use with the technology include, but are not limited to, personal computers, server computers, handheld or laptop devices, cellular telephones, wearable electronics, gaming consoles, tablet devices, multiprocessor systems, microprocessor-based systems, set-top boxes, programmable user electronics, network PCs, minicomputers, mainframe computers, distributed computing environments that include any of the above systems or devices, or the like.

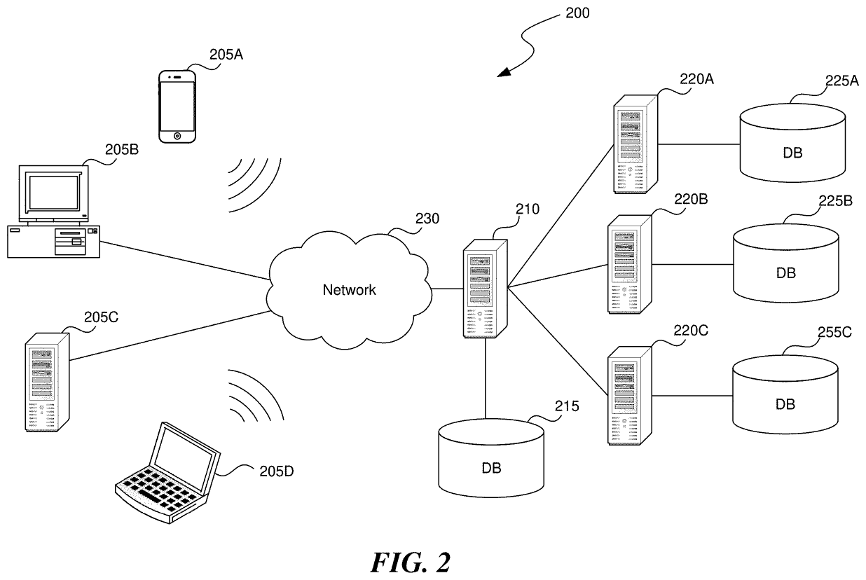

FIG. 2 is a block diagram illustrating an overview of an environment 200 in which some implementations of the disclosed technology can operate. Environment 200 can include one or more client computing devices 205A-D, examples of which can include device 100. Client computing devices 205 can operate in a networked environment using logical connections through network 230 to one or more remote computers, such as a server computing device.

In some implementations, server 210 can be an edge server which receives client requests and coordinates fulfillment of those requests through other servers, such as servers 220A-C. Server computing devices 210 and 220 can comprise computing systems, such as device 100. Though each server computing device 210 and 220 is displayed logically as a single server, server computing devices can each be a distributed computing environment encompassing multiple computing devices located at the same or at geographically disparate physical locations. In some implementations, each server 220 corresponds to a group of servers.

Client computing devices 205 and server computing devices 210 and 220 can each act as a server or client to other server/client devices. Server 210 can connect to a database 215. Servers 220A-C can each connect to a corresponding database 225A-C. As discussed above, each server 220 can correspond to a group of servers, and each of these servers can share a database or can have their own database. Databases 215 and 225 can warehouse (e.g. store) information such as user data, company data, user specifications data, company schema data, match score data, recommendation data, machine learning data, or product and service data. Though databases 215 and 225 are displayed logically as single units, databases 215 and 225 can each be a distributed computing environment encompassing multiple computing devices, can be located within their corresponding server, or can be located at the same or at geographically disparate physical locations.

Network 230 can be a local area network (LAN) or a wide area network (WAN), but can also be other wired or wireless networks. Network 230 may be the Internet or some other public or private network. Client computing devices 205 can be connected to network 230 through a network interface, such as by wired or wireless communication. While the connections between server 210 and servers 220 are shown as separate connections, these connections can be any kind of local, wide area, wired, or wireless network, including network 230 or a separate public or private network.

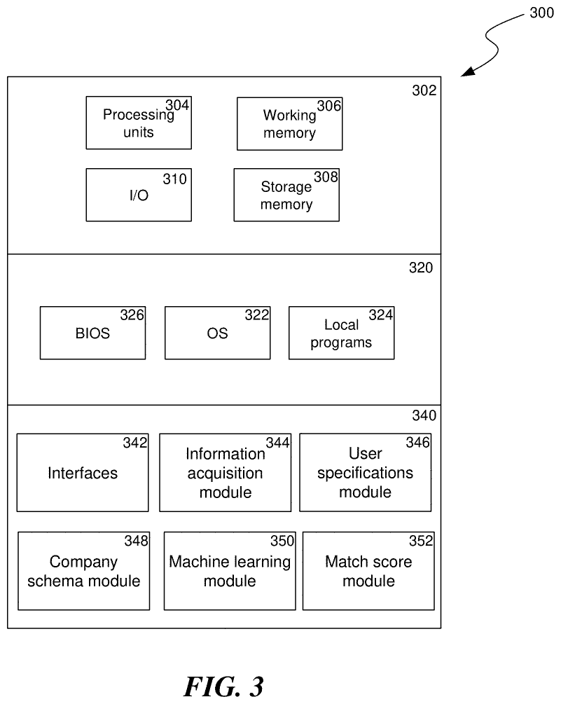

FIG. 3 is a block diagram illustrating components 300 which, in some implementations, can be used in a system employing the disclosed technology. The components 300 include hardware 302, general software 320, and specialized components 340. As discussed above, a system implementing the disclosed technology can use various hardware including processing units 304 (e.g. CPUs, GPUs, APUs, etc.), working memory 306, storage memory 308 (local storage or as an interface to remote storage, such as storage 215 or 225), and input and output devices 310. In various implementations, storage memory 308 can be one or more of: local devices, interfaces to remote storage devices, or combinations thereof. For example, storage memory 308 can be a set of one or more hard drives (e.g. a redundant array of independent disks (RAID)) accessible through a system bus or can be a cloud storage provider or other network storage accessible via one or more communications networks (e.g. a network accessible storage (NAS) device, such as storage 215 or storage provided through another server 220). Components 300 can be implemented in a client computing device such as client computing devices 205 or on a server computing device, such as server computing device 210 or 220.

General software 320 can include various applications including an operating system 322, local programs 324, and a basic input output system (BIOS) 326. Specialized components 340 can be subcomponents of a general software application 320, such as local programs 324. Specialized components 340 can include information retrieval module 344, user specifications module 346, company schema module 348, machine learning module 350, match score module 352, and components which can be used for providing user interfaces, transferring data, and controlling the specialized components, such as interfaces 342. In some implementations, components 300 can be in a computing system that is distributed across multiple computing devices or can be an interface to a server-based application executing one or more of specialized components 340. Although depicted as separate components, specialized components 340 may be logical or other nonphysical differentiations of functions and/or may be submodules or code-blocks of one or more applications.

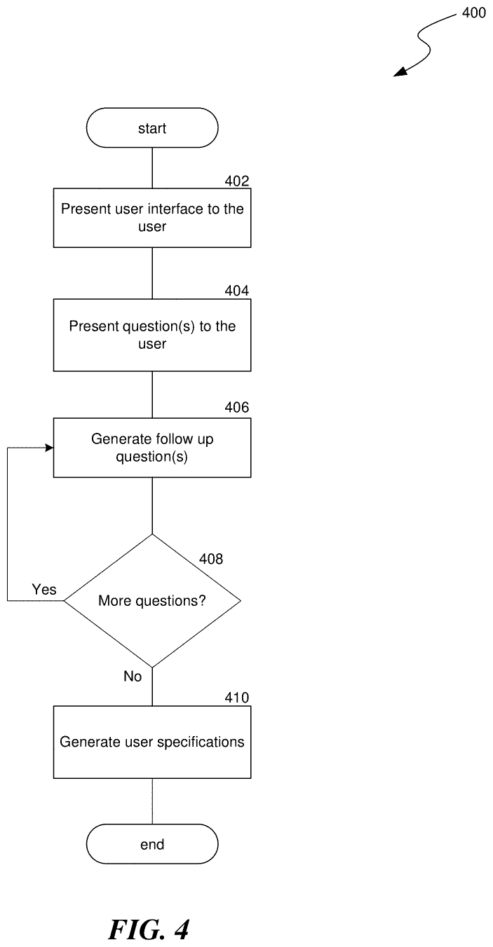

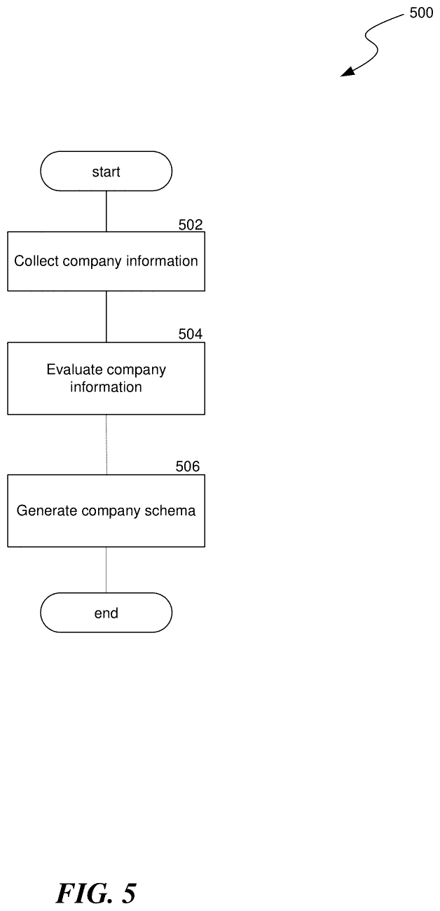

The information acquisition module 344 can collect information from users and companies. The information can be collected from user interfaces, APIs, website scrapping, user responses to questions, user provided information, company provided information, direct access to user or company accounts/databases, or social media accounts. For example, a user provides the information in a user interface by answering a series of questions about products and services the user is interested in. Additional details on collecting information are provided below in relation to blocks 404, 406, and 408 of FIG. 4 and block 502 of FIG. 5.

The user specifications module 346 can generate user specifications based on the collected information. The user specifications can indicate the products and services (e.g., insurance providers and rates, appliances, user devices, furniture, make and model of cars, security systems, fire alarms, etc.) the user currently has and/or products and services the user is interest in obtaining. The user specifications can indicate a time window the user would like to obtain the product or service. In some embodiments, the user specifications can indicate a user is open to suggestions for products or services based on the collected information. Additional details on user specifications are provided below in relation to block 410 in FIG. 4.

The company schema module 348 can generate a company schema based on the collected information. The company schema can include the products and services the company offers, the rates for the products and services, the terms and length of services, warranties on the products and services, customer reviews of the company, the age of the company, company location, in person or remote contact access, hours or operation, phone number, email address, website links, or company rankings. Additional details on company schemas are provided below in relation to block 506 in FIG. 5.

In some embodiments, the machine learning module 350 may be configured to analyze user history of selecting companies with products and services to determine similar products and services to present to the user as recommendations. The machine learning module 350 may be configured to identify similar products and services based on at least one machine-learning algorithm trained on at least one dataset reflecting a user's product and services preferences. The at least one machine-learning algorithms (and models) may be stored locally at databases and/or externally at databases. Product and service selection devices may be equipped to access these machine learning algorithms and intelligently select particular companies with products and services to display to the user based on at least one machine-learning model that is trained on a user's historical product and service history. For example, if a user frequently purchases a product or service, the user's product and service history may be collected to train a machine-learning model to then automatically present similar products and services to the user.

As described herein, a machine-learning (ML) model may refer to a predictive or statistical utility or program that may be used to determine a probability distribution over one or more character sequences, classes, objects, result sets or events, and/or to predict a response value from one or more predictors. A model may be based on, or incorporate, one or more rule sets, machine learning, a neural network, or the like. In examples, the ML models may be located on the user device, company device, system device, a network appliance (e.g., a firewall, a router, etc.), or some combination thereof. The ML models may process user product and service history and other data stores of user preferences (e.g., social media profiles) to determine which products and services should be automatically shown, or, in some examples, suggested to the user for review or purchase. Determining whether a certain product or service should be displayed may comprise identifying various characteristics of a user's product and service history and preferences. For instance, if a user has a social media profile that displays several photographs of a house with household appliances, then the product and service recommendation system described herein may determine that products and services related to homes should be recommended to the user, such as home insurance or warranties for the appliances. Similarly, if a user posts certain social media items reflecting the purchase of a new car, the product and service recommendation system may determine companies that provide car maintenance or vehicle insurance should be recommended. Based on an aggregation of data from a user's product and service history, social media profiles, and other user data stores, at least one ML model may be trained and subsequently deployed to automatically display and/or suggest for products and services that a particular user may select. The trained ML model may be deployed to one or more devices. As a specific example, an instance of a trained ML model may be deployed to a server device and to a user device. The ML model deployed to a server device may be configured to be used by the user device when, for example, the client device is connected to the Internet. Conversely, the ML model deployed to a client device may be configured to be used by the client device when, for example, the client device is not connected to the Internet. In some instances, a user device may not be connected to the Internet but still configured to receive satellite signals with products and service details. In such examples, the ML model may be locally cached by the client device.

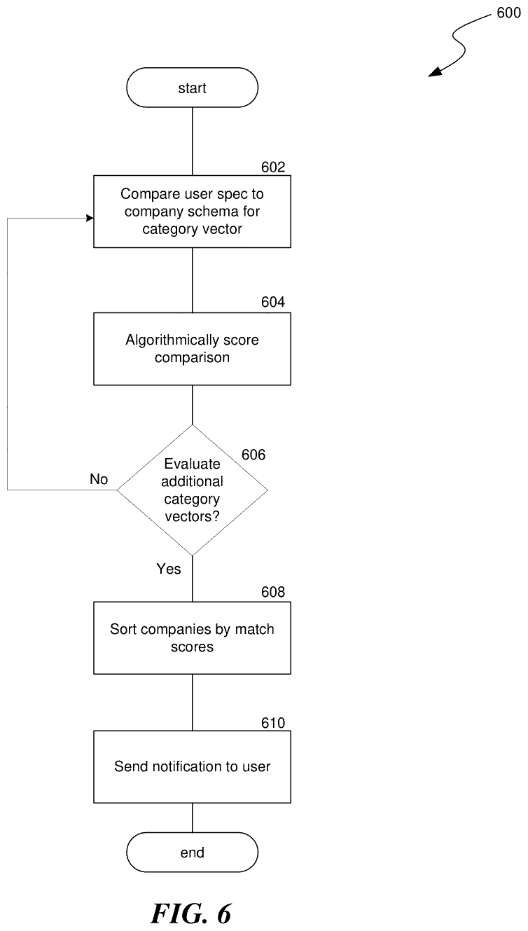

In some embodiments, the match score module 352 can generate a match score between the user specifications and the company schemas. The match score module 352 can compare the user specifications with company schemas to determine a company or companies that provide products and services that align with the user's needs or the user is interested in. The match score can indicate whether a company provides products or services that the user wants. In an example, a match score of 100% indicates the company can provide the user with products or services the user needs. In another example, a match score of 80% indicates the company can provide the user with most of the products and services that the user needs, however the company cannot provide all the products and services the user is looking for. The companies with match scores above a threshold value (e.g., any user defined value or predetermined value) can be presented to the user. Additional details on generating match scores are provided below in relation to FIG. 6.

Those skilled in the art will appreciate that the components illustrated in FIGS. 1-3 described above, and in each of the flow diagrams discussed below, may be altered in a variety of ways. For example, the order of the logic may be rearranged, substeps may be performed in parallel, illustrated logic may be omitted, other logic may be included, etc. In some implementations, one or more of the components described above can execute one or more of the processes described below.

FIG. 4 is a flow diagram illustrating a process 400 used in some implementations of the present technology for generating user (consumer) specifications. Process 400 can be initially performed when a user registers for the recommendation service. Alternatively or in addition, process 400 can be performed to update existing user specifications (e.g. periodically, such as daily, weekly, etc.), when a user provides information, when an event changes in the user's life, or process 400 can receive data pushed to it from the various data sources as the data sources are updated. In various implementations, process 400 can be performed locally on the user device or performed by cloud-based device(s) that can support product and service recommendations.

At block 402, process 400 presents the user with a user interface. In some implementations, process 400 can interact with the user via the user interface. The user can access the user interface via an application or web browser on a user device, through a mobile or other application, etc. The user can receive the user interface when registering for the product and service recommendation system.

Process 400 collects user information (data) from the user via the user interface. At step 404, process 400 presents one or more questions to the user to gather information (e.g., gather a category vector). Based on the responses to the questions, at step 406 process 400 generates follow up questions. For example, process 400 asks the user's age, whether the user has declared bankruptcy, if so when did the user declare bankruptcy, whether the user owns or rents a house/condo/apartment, if so what is the size and value of the house/condo/apartment, does the house/condo/apartment have a pool, whether the user owns or leases any vehicles (e.g., a car, boat, jet ski, plane, motorcycle, scooter, tractor, etc.), if so what are the year, make and model of the vehicles, whether the user is married or single, number of dependents, types of home appliances (e.g., oven, stove, washer, dryer, refrigerator, ceiling fan, etc.), types of heating and cooling systems (e.g., central air, heat pump, wood/pellet stove, etc.), type of security system, type of fire alarm system, current insurance (e.g., vehicle, home, life, medical, etc.) provider, coverage, and fees, vehicle insurance coverage (e.g., towing, road side assistance, collision, etc.), warranties the user has on any products or services, user salary, user's location/address, or user contact information. In some implementations, the user can indicate proprietary information about user-specific category needs, such as information related to products and services the user is interested in purchasing. For example, the user is shopping for a house or car, looking for cheaper insurance, or has an approaching life event (e.g., getting married, graduating from school, having a baby, etc.). In some implementations, process 400 can retrieve user information from user social media accounts to determine what the user is interested in.

At step 408, process 400 determines whether more questions should be asked to gather additional information. If additional information is needed, process 400 can return to step 406 and generate additional follow up questions to gather the additional information. Process 400 can generate questions until the user requirements are determined. Once process 400 determines that all the questions have been answered, at block 410, process 400 generates user specifications based on the collected information. The user specifications can indicate the user's category specifications (e.g., user criteria or needs), such as the products and services (e.g., insurance providers and rates, appliances, user devices, furniture, make and model of cars, security systems, fire alarms, etc.) the user currently has and/or products and services the user is interested in obtaining. The user specifications can indicate when the user would like to obtain a product or service, the fee the user is willing to pay (e.g., maximum amount of money the user will spend), or how long the user wants the product or service. In some embodiments, the user specifications can indicate a user is open to suggestions for products or services based on the collected information.

FIG. 5 is a flow diagram illustrating a process 500 used in some implementations of the present technology for generating a company schema. Process 500 can be initially performed when a company registers for the recommendation service. Alternatively, or in addition, process 500 can be performed to update an existing company schema (e.g. periodically, such as daily, weekly, etc.), when a company provides a information or process 500 can receive data pushed to it from the various data sources as the data sources are updated. In various implementations, process 500 can be performed locally on the company devices or performed by cloud-based device(s) that can support product and service recommendations.

At block 502, process 500 collects company information. The information can be collected from APIs, website scrapping, user reviews of the products and services of the company, company provided information, direct access to company accounts/databases, or ask questions regarding the company and the products and services in chatbots (e.g., pose as a consumer and inquire about good or services). Employees of the company can input, into a user interface, information regarding the products and services the company provides, or the information can be continually scrapped from the company website or database. In some implementations, process 500 can present a user interface to the company and interact with the company via the user interface. The employees of a company can access the user interface via an application or web browser on a company device, through a mobile or other application, etc. The company can receive the user interface when the company registers for the product and service recommendation system.

At block 504, process 500 evaluates the collected company information. Process 500 can evaluate product marketing claims of a company and evaluate service contracts or other legal/compliance documents that may exist. Using the evaluations, process 500 can identify fees associated with products and services, term lengths of contracts, age requirements or limits for each product or service, success or failure of each product, user feedback regarding each product and service, whether the user information is kept private upon purchasing a product or service, or whether the product or service has a warranty.

At block 506, process 500 generates a company schema based on the collected information. The company schema can include the company specifications, such as products and services the company offers, the rates for the products and services, the terms and length of services, warranties on the products and services, customer reviews of the company, the age of the company, company location, in person or remote contact access, hours or operation, phone number, email address, website links, or company rankings.

FIG. 6 is a flow diagram illustrating a process 600 used in some implementations of the present technology for determining a match score between a company schema and user specifications. Process 600 can be initially performed when a user (consumer or company) registers for the recommendation service. Alternatively, or in addition, process 600 can be performed to update an existing user specifications (e.g., periodically, such as daily, weekly, etc.), when a user provides information or process 600 can receive data pushed to it from the various data sources as the data sources are updated. In various implementations, process 600 can be performed locally on the company devices or performed by cloud-based device(s) that can support product and service recommendations.

At block 602, process 600 compares user specifications to company schema to determine a category vector. For example, process 600 determines if a company satisfies a feature that the user is requesting. Process 600 can determine a match score between the user specifications and a company (or multiple companies) schema. Process 600 can implement a matching algorithm (e.g., 100×(match(1),noMatch(x<1))) to determine the match score. The algorithm can be based on a reduce function, such that the ellipsis represents repeating the calculation until there are no more criteria to score.

At step 604, process 600 algorithmically compares the match scores. Process 600 can use a reduce function and multiply the current score by a coefficient (e.g., coefficient's value determined at step 602). In some implementations, process 600 can take a user's category specifications (e.g., products or services the user needs), and score the category specifications with respect to individual company schema. Process 600 can produce user-specific matches in the form of company recommendations sorted in a descending order list based on the company's respective scores, such as 0-100, with 100 indicating a complete match and 0 indicating no match.

If the company's product or service offering does not match the users input for a given item (e.g., pool coverage), the multiplier for that iteration of the algorithm is less than 1 (based on a proprietary category relevance coefficient), which reduces the total score below 100. The user can set the category relevance coefficient based the importance of the category to the user. The algorithm can execute the reduce function until it produces a final score. The algorithm follows the ellipsis in a continuation of the match, noMatch multiplier function for each comparison of the user's need to the company's schema. For example, if a first company offered 1) air conditioning (A/C) coverage, 2) appliance coverage but not 3) pool coverage, and the user has expressed interest (in the user specifications) in all three coverage types, the results would be as follow: 1) for the A/C coverage, the first product offering/user input matches, so the iteration of the algorithm has a multiplier of one (e.g., 100×1=100); 2) for appliance coverage, the second product offering/user input matches, so this iteration of the algorithm has a multiplier of one (e.g., 100×1×1=100); 3) for pool coverage: noMatch. If the user set a category relevance coefficient to 0.8 (e.g., pool coverage is fairly important to the user) the result would be 100×1×1×0.8=80. If a second company were to offer the same coverage as the first company with the exception that the second company has pool coverage, the second company (with a score of 100) would be algorithmically matched with the user based on the user's information in the user specifications.

In some implementations, a noMatch can disqualify a company from meeting the user's needs. For example, if the user is in a location and the company does not operate in the user's location, the multiplier for that iteration of the algorithm is 0, and the company's score will become 0. In some implementations, process 600 can score companies based on threshold values. For example, a car warranty company offering services to vehicles with less than 200 k miles can receive a lower score than a warranty company which offers services to vehicles with more than 200 k miles. In another example, a moving company which has origin and destination requirements by state or zip code, can receive a lower score than moving companies without the origin or destination requirements.

In some implementations, process 600 determines whether the match score is above a threshold value (e.g., any numerical value such as a value of 5 or an incremental value such as 80.2). The threshold value can be a user-defined value from the user specifications, a predetermined recommendation system value, or an adjustable value. When the match score is below a threshold value, process 600 can repeat block 602 until identifying a company with a match score above the threshold value. In some implementations, process 600 continues until all the company schemas are compared with the user specifications and assigned a match score. In some implementations, process 600 continues until a predetermined number of companies have match scores above the threshold match score. For example, a user can specify that the user wants to review a specific number of companies. Process 600 can filter companies from the user's results where the match score is below the threshold value, to ensure the user does not match with a company that does not meet the user's needs.

At block 606, process 600 determines whether to evaluate additional category vectors. When additional category vectors need to be evaluated, process 600 continues to step 602. When all the category vectors have been evaluated, at block 608, process 600 compares the determined match scores of the companies and sorts the companies based on the match scores. For example, the companies are sorted by relevance, such as the company with the highest match scores is listed as the most relevant.

At block 610, process 600 sends a notification to the user with the recommended company or companies. Process 600 can present the user with the highest scored company and the other companies in descending order based on the match scores. In some cases, process 600 displays the match scores to the user for each company. The results can display to the user a multi-match score (e.g., 2-any number of results) of the companies. The user can select (in real-time) the companies to review the products and services the companies provide. In some cases, the user can purchase a product or service from a company. Process 600 can update the user specifications based on the company the user selects and the product or service the user purchases.

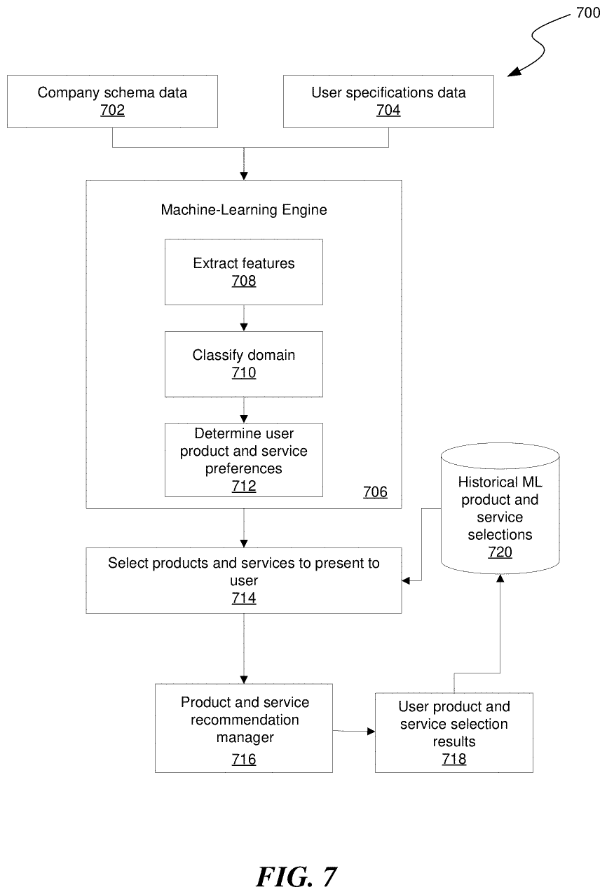

FIG. 7 illustrates an example machine learning system for recommending products and services, as described herein. FIG. 7 begins at operations 702 and 704, where company schema data 702 and user (consumer) specifications data 704 (including user product and service selection history) are received by the product and service recommendation system via a device. The data may be received by a user device and/or a remote web server device. In the instance of a remote web server (such as servers 210, 220A, 220B, and/or 220C), the company schema data and the user specifications data may initially be collected from a client device and then transmitted via a wireless network (over network(s) 220) to a remote web server device, where the remote web server device receives the company schema data and the user specifications data. The received data may be converted into particular representations that may be understood and processed by a machine utilizing machine-learning algorithms (e.g., ML Engine 706) to intelligently disassemble the company schema data and user specifications data and identify products and services for the user.

The company schema data 702 and the user specifications data 704 may be transmitted to Machine-Learning (ML) Engine 706, where the data may be used to train at least one ML model and/or compared against an already-trained ML model or models. User specifications data 704 may comprise data from a user's social media account, user responses to a profile survey, and/or data from other sources. In some aspects, the first operation in ML Engine 706 may be extract features 708. At operation 708, certain features may be extracted from the company schema data 702 and the user specifications data 704, including but not limited to contextual features and lexical features. For instance, the lexical features that may be analyzed include, but are not limited to, word n-grams that may appear in a social media status update, text messages, emails, and/or other text-based medium hosting user specifications data. A word n-gram is a contiguous sequence of n words from a given sequence of text. For instance, a particular social media update earlier in the day from the user may state: “just bought my dream car!” The word n-gram that may be extracted in this instance is “bought dream car.” The intelligent interruption detection system now knows that the user purchased a car and are excited about the car, and therefore, the system may identify products and services related to recently purchased cars. As should be appreciated, analyzing word n-grams may allow for a deeper understanding of the user and therefore provide more accurate and intelligent product and service selection and recommendations for the user. The machine-learning algorithms from ML Engine 706 may be able to compare thousands of n-grams, lexical features, and contextual features in a matter of seconds to extract the relevant features of a social media, text, and/or email message. Such rapid comparison are impossible to employ manually.

The contextual features that may be analyzed at operation 708 may include, but are not limited to, a top context and an average context. A top context may be a context that is determined by comparing the topics and keywords associated with a particular product or service and/or text-based input (e.g., social media update, text message, email, search engine inquiry, etc.) to a set of preloaded contextual cues. An average context may be a context that is determined by comparing the topics and keywords of historically processed text-based input data, historical selection of products and services, the user's level of enjoyment of historically selected products and services, user specification data (e.g., scraped from public social media websites), and other data. The feature extraction operation 708 may also skip contextually insignificant data when analyzing the input data. For example, a string token in a message input may be associated with articles, such as “a” and “an.” Because articles are typically insignificant in the English language the feature extraction operation 708 may ignore these article tokens.

ML Engine 706 may be configured to not only process text-based data, but also process image and video data. At operation 708, features that may be extracted from an image or video may include but are not limited to faces, settings, items, devices, and other objects. Objects may be identified at operation 708 by applying an image recognition algorithm stored within ML Engine 706. The image recognition algorithm may be able to identify objects, such as people, devices, appliances, vehicles geographic locations, settings, and points of interest, among other examples. Similarly, ML Engine 706 may be configured to identify objects in images and multimedia files from a user's social media profile and further determine a user's preferences for products or services.

Once the features are extracted at operation 708, the domain of the input data (company schema data 702 and user specification data 704) may be classified at operation 710. The features that were extracted at operation 708 may be grouped together into specific classifiers for further analysis at operation 710. Specifically, classifying the domain of the extracted features at operation 710 may utilize statistical models or predefined policies (i.e., prior knowledge, historical datasets) to determine the proper domain of classification. For example, if a user previously selected a product or service associated with purchasing a home, one of the features that may have been extracted at operation 708 was a household object (from the title of a post, user input, and/or images of the background environment in a video or image, etc.) and/or word n-gram describing “homeowner.” At operation 710, the particular product or service (e.g., “home insurance”) may be associated with a broader domain classification such as a “insurance” domain, in which products and services related to home, vehicle, life, and medical insurance generally may be classified.

At operation 712, the product and service preferences of the user may be determined. For example, historical product and service selection history may indicate that the user does not own a car or need vehicle insurance, so the product and service recommendation system described herein may assume that the likelihood of a user wanting a company that provides products and services related to vehicles is low. Considering the user specifications data 704 and the features extracted at operation 708 (e.g., via public social media postings), however, might reveal that the user is currently moving out of the city to an area where public transportation is limited. Further, the data extracted from the user specifications data indicates that the user has been shopping for a car. As such, the immediate preferences of the user to need products and services related to vehicles may increase, and the product and service recommendation system may determine that a vehicle related products and services is likely preferred by the user.

After the features are extracted at operation 708, domains classified at operation 710, and preferences determined at operation 712, the system may determine which products and services should be displayed at operation 714. Continuing from the earlier “homeowner” example, a product and service history may demonstrate that the user has been shopping for a home insurance provider. The possible domain classification for a home insurance may be “insurance.” As such, other products and services that are classified as “insurance” domains may be more relevant to the user. Specifically, if the user is shopping for home insurance, then the product and service recommendation system may determine that the user may want to find an insurance provider to bundle home insurance with the vehicle insurance.

Additionally, at operation 714, the products and services that are ultimately decided to be presented may be determined using historical selections from the Historical ML product and service selections database 720. For instance, certain products and services that were selected by the user may be notated in database 720, and product and service suggestions that were ignored (not selected) by the user may be notated in database 720, as well. The products and services that were selected and purchased by the user may further help determine the products and services to be select at step 714. After products and services are selected at operation 714, the method proceeds to product and service recommendation manager 716, where the products and services are identified and recommended to the user. For example, the companies that provide the products and services are provided to the user with a match score as described in FIG. 6

Once a product or service is selected (e.g., purchased) by the user at step 718, the selected product and service selection results are then subsequently stored in Historical ML products and services selections database 720 for future reference (e.g., in determining the products or services to present to the user at step 714). Once a product or service is selected, a notification may be provided to the user, requesting feedback of whether the user would select (purchase) the product or service in the future.

Several implementations of the disclosed technology are described above in reference to the figures. The computing devices on which the described technology may be implemented can include one or more central processing units, memory, input devices (e.g., keyboard and pointing devices), output devices (e.g., display devices), storage devices (e.g., disk drives), and network devices (e.g., network interfaces). The memory and storage devices are computer-readable storage media that can store instructions that implement at least portions of the described technology. In addition, the data structures and message structures can be stored or transmitted via a data transmission medium, such as a signal on a communications link. Various communications links can be used, such as the Internet, a local area network, a wide area network, or a point-to-point dial-up connection. Thus, computer-readable media can comprise computer-readable storage media (e.g., “non-transitory” media) and computer-readable transmission media.

Reference in this specification to “implementations” (e.g. “some implementations,” “various implementations,” “one implementation,” “an implementation,” etc.) means that a particular feature, structure, or characteristic described in connection with the implementation is included in at least one implementation of the disclosure. The appearances of these phrases in various places in the specification are not necessarily all referring to the same implementation, nor are separate or alternative implementations mutually exclusive of other implementations. Moreover, various features are described which may be exhibited by some implementations and not by others. Similarly, various requirements are described which may be requirements for some implementations but not for other implementations.

As used herein, being above a threshold means that a value for an item under comparison is above a specified other value, that an item under comparison is among a certain specified number of items with the largest value, or that an item under comparison has a value within a specified top percentage value. As used herein, being below a threshold means that a value for an item under comparison is below a specified other value, that an item under comparison is among a certain specified number of items with the smallest value, or that an item under comparison has a value within a specified bottom percentage value. As used herein, being within a threshold means that a value for an item under comparison is between two specified other values, that an item under comparison is among a middle specified number of items, or that an item under comparison has a value within a middle specified percentage range. Relative terms, such as high or unimportant, when not otherwise defined, can be understood as assigning a value and determining how that value compares to an established threshold. For example, the phrase “selecting a fast connection” can be understood to mean selecting a connection that has a value assigned corresponding to its connection speed that is above a threshold.

As used herein, the word “or” refers to any possible permutation of a set of items. For example, the phrase “A, B, or C” refers to at least one of A, B, C, or any combination thereof, such as any of: A; B; C; A and B; A and C; B and C; A, B, and C; or multiple of any item such as A and A; B, B, and C; A, A, B, C, and C; etc.

Although the subject matter has been described in language specific to structural features and/or methodological acts, it is to be understood that the subject matter defined in the appended claims is not necessarily limited to the specific features or acts described above. Specific embodiments and implementations have been described herein for purposes of illustration, but various modifications can be made without deviating from the scope of the embodiments and implementations. The specific features and acts described above are disclosed as example forms of implementing the claims that follow. Accordingly, the embodiments and implementations are not limited except as by the appended claims.

Any patents, patent applications, and other references noted above are incorporated herein by reference. Aspects can be modified, if necessary, to employ the systems, functions, and concepts of the various references described above to provide yet further implementations. If statements or subject matter in a document incorporated by reference conflicts with statements or subject matter of this application, then this application shall control.

I/We claim:

1. A method for prioritizing service or product recommendations, the method comprising:
collecting user information based on user responses to an information acquisition;
analyzing the user information to generate user specifications based on products or services associated with the user;
generating a company schema based on products or services a company provides;
determining a match score based on a comparison of the user specifications and the company schema, wherein the match score indicates a percentage of products or services that are associated with the user that relate to products or services that the company provides; and
in response to the match score being above a threshold value, displaying, on a user interface, data correlating the match score with the products and services the company provides.

2. The method of claim 1, further comprising:
identifying two or more companies based on match scores being above the threshold value; and
presenting, on the user interface, the two or more companies in a descending order based on the match scores.

3. The method of claim 2, further comprising:
receiving a real-time selection of one of the two or more companies by the user.

4. The method of claim 1, wherein the company is recommended based on at least one machine-learning algorithm, wherein the at least one machine-learning algorithm is trained based on at least one dataset associated with a past product and service selection history of the user.

5. The method of claim 1, further comprising:
collecting information about the products or services the company provides; and
organizing the collected information into categories based on product or service type.

6. The method of claim 1, further comprising:
updating the user specifications based on the user selecting services or products from the company.

7. The method of claim 1, wherein the products or services associated with the user are products or services the user has purchased or intends to purchase.

8. A computing system for prioritizing service or product recommendations, the computing system comprising:
one or more processors; and
one or more memories storing instructions that, when executed by the one or more processor, cause the computing system to perform a process comprising:
collecting user information based on user responses to an information acquisition;
analyzing the user information to generate user specifications based on products or services associated with the user;
generating a company schema based on products or services a company provides;
determining a match score based on a comparison of the user specifications and the company schema, wherein the match score indicates a percentage of products or services that are associated with the user that relate to products or services that the company provides; and
in response to the match score being above a threshold value, displaying, on a user interface, data correlating the match score with the products and services the company provides.

9. The computing system of claim 8, wherein the process further comprises:
identifying two or more companies based on match scores being above the threshold value; and
presenting, on the user interface, the two or more companies in a descending order based on the match scores.

10. The computing system of claim 9, wherein the process further comprises:
receiving a real-time selection of one of the two or more companies by the user.

11. The computing system of claim 8, wherein the company is recommended based on at least one machine-learning algorithm, wherein the at least one machine-learning algorithm is trained based on at least one dataset associated with a past product and service selection history of the user.

12. The computing system of claim 8, wherein the process further comprises:
collecting information about the products or services the company provides; and
organizing the collected information into categories based on product or service type.

13. The computing system of claim 8, wherein the process further comprises:
updating the user specifications based on the user selecting services or products from the company.

14. The computing system of claim 8, wherein the products or services associated with the user are products or services the user has purchased or intends to purchase.

15. A machine-readable storage medium having machine executable instructions stored thereon that, when executed by one or more processors, direct the one or more processors to perform a method for prioritizing service or product recommendations, the method comprising:
collecting user information based on user responses to an information acquisition;
analyzing the user information to generate a user specifications based on products or services associated with the user;
generating a company schema based on products or services a company provides;
determining a match score based on a comparison of the user specifications and the company schema, wherein the match score indicates a percentage of products or services that are associated with the user that relate to products or services that the company provides; and
in response to the match score being above a threshold value, displaying, on a user interface, data correlating the match score with the products and services the company provides.

16. The machine-readable storage medium of claim 15, wherein the method further comprises:
identifying two or more companies based on match scores being above the threshold value; and
presenting, on the user interface, the two or more companies in a descending order based on the match scores.

17. The machine-readable storage medium of claim 16, wherein the method further comprises:
receiving a real-time selection of one of the two or more companies by the user.

18. The machine-readable storage medium of claim 15, wherein the company is recommended based on at least one machine-learning algorithm, wherein the at least one machine-learning algorithm is trained based on at least one dataset associated with a past product and service selection history of the user.

19. The machine-readable storage medium of claim 15, wherein the method further comprises:
collecting information about the products or services the company provides; and
organizing the collected information into categories based on product or service type.

20. The machine-readable storage medium of claim 15, wherein the method further comprises:
updating the user specifications based on the user selecting services or products from the company.
